(19) United States
(12) Patent Application Publication
(10) Pub. No.: US 2009/0164537 A1
(43) Pub. Date: Jun. 25, 2009

(54) METHOD FOR STORING FILE PATHS AND FILE NAMES

(75) Inventor: SHENG-CHIEN HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/182,103

(22) Filed: Jul. 29, 2008

(30) Foreign Application Priority Data
Dec. 24, 2007 (CN) 200710203375.8

(51) Int. Cl. G06F 12/02

(52) U.S. Cl. 707/205; 707/E17.01; 711/E12.002

(57) ABSTRACT

A computer-implemented method for storing file paths and file names is disclosed. The method includes creating a path table, creating a file table, receiving a file ID sent from an application, and obtaining a file name, a length of the file name, and a directory ID corresponding to the file from the file table according to the file ID. The method further includes obtaining a file path from the path table according to the directory ID corresponding to the file, merging the file path and the file name so as to generate a merged character string, and sending the merged character string, a length of the file path and a length of the file name to the application for assigning storage space for the file based on the length of the file path and the file name.

### BACKGROUND OF THE INVENTION

1. Field of the Invention

Embodiments of the present disclosure relate to file management methods, and more particularly to a method for storing file paths and file names.

2. Description of Related Art

More and more multimedia files are used by applications in a mobile phone nowadays. For example, an image file may be used by a background picture setting program. In one method, a path of a used file and a corresponding file name of the file are stored by each of the applications in the mobile phone respectively.

However, if a file is used by more than one application, then the file path and the file name would be repeatedly stored by each application. In another problem, if a file is used by an application more than one times, the file path and the file name would also be stored by the application repeatedly.

Therefore, what is needed is a method for storing file paths and file names, which can reduce the storage space to store the file paths and the file names.

### SUMMARY OF THE INVENTION

A method for storing file paths and file names is provided. The method includes the blocks of: creating a path table, the path table being configured for storing file paths, each file path including one or more directories, each directory including a directory name, a length of the directory name, a directory ID, and a parent directory ID of the directory; creating a file table, the file table being configured for storing files, each file including a file name, a length of the file name, a directory ID corresponding to the file, and a file ID; receiving a file ID sent from an application, and obtaining a file name, a length of the file name, and a directory ID corresponding to the file from the file table according to the file ID; obtaining a file path from the path table according to the directory ID corresponding to the file; merging the file path and the file name so as to generate a merged character string, and sending the merged character string, a length of the file path and a length of the file name to the application for assigning storage space for the file based on the length of the file path and the file name.

Other systems, methods, features, and advantages of the present invention will become apparent to one with skill in the art upon examination of the following drawings and detailed description.

### BRIEF DESCRIPTION OF THE DRAWINGS

FIG. 1 is a schematic diagram of one embodiment of a system for storing file paths and file names;

FIG. 2 is a flowchart of one embodiment of a method for storing file paths and file names;

FIG. 3 is a detailed flowchart of block S400 of FIG. 2;

FIG. 4 is a flowchart of adding a new file path into a path table;

FIG. 5 is a flowchart of deleting a file path from the path table;

FIG. 6 is a flowchart of renaming a directory name of a file path in the path table;

FIG. 7 is a flowchart of adding a new file into a file table;

FIG. 8 is a flowchart of deleting a file from the file table; and

FIG. 9 is a flowchart of renaming a file name in the file table.

### DETAILED DESCRIPTION OF THE INVENTION

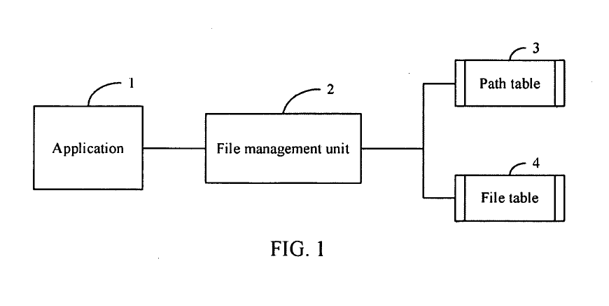

FIG. 1 is a schematic diagram of one embodiment of a system for storing file paths and file names. In one embodiment, the system includes an application 1, a file management unit 2, a path table 3, and a file table 4. It may be understood that a file path may be divided into sequential directories by a backslash character (‘\’). A file path is equal to a path of a directory including the file. For example, an exemplary file path of a file “a.txt” is “D:\Pictures\aaa\bbb.” The file path can be divided into three sequential directories “D:\Pictures,” “aaa,” and “bbb,” wherein the directory “D:\Pictures” is the first directory, the directory “bbb” includes the file “a.txt.” Thus, the directory path of “bbb” is “D:\Pictures\aaa\bbb.” Depending on the embodiment, it may be understood that the file path may be divided into other sequential characters, such as the forward slash character (‘/’) as used by the Apple Mac OS X and UNIX platforms.

The path table 3 is configured for storing file paths. Each file path typically includes one or more directories. Each directory typically includes a directory name, a length of the directory name, a directory identifier (ID), and a parent directory ID of the directory. One exemplary path table (Table 1) is shown as follows.

TABLE 1

| Parent | | Length of | Directory |
|---|---|---|---|
| directory ID | Directory ID | directory name | name |
| 0 | 1 | 15 | D:\Pictures |
| 0 | 2 | 13 | D:\Sounds |
| 1 | 3 | 3 | aaa |
| 3 | 4 | 3 | bbb |
| 1 | 5 | 3 | ccc |
| . . . | | | |
| . . . | | | |

In the path table 3, each row stores a directory name, a length of the directory name, a directory ID, and a parent directory ID. The directory ID of each directory in the path table 3 is different from the others. If the directory is the first directory of the file path, then the corresponding parent directory ID is zero. For example, an exemplary file path “D:\Pictures\aaa” has two directories “D:\Pictures” and “aaa,” where the directory “D:\Pictures” is the first directory. Thus, the parent directory ID of the directory “D:\Pictures” is zero. The directory “aaa” is a sub-directory followed the directory “D:\Pictures,” so the parent directory ID of the directory “aaa” in the Table 1 is one (i.e., the directory ID of the directory “D:\Pictures” in the Table 1).

In the path table 3, a directory path may equals a parent directory path plus the directory name. For example, in the Table 1, the directory path of “bbb” equals the directory path of “aaa” plus “bbb,” the directory path of “aaa” equals the directory path of “D:\Pictures” plus “aaa,” the directory path of “D:\Pictures” equals “D:\Pictures” as the directory “D:\Pictures” is the first directory. To connect all the directory name with the ‘\’ character so as to generate the directory path of “bbb” (i.e., “D:\Pictures\aaa\bbb”).

The file table 4 is configured for storing files. Each file typically includes a file name, a length of the file name, a directory ID corresponding to the file, and a file ID. The directory ID corresponding to a file is the directory ID of a directory including the file in the path table 3. For example, if a file “b.txt” is stored in the directory “bbb,” the directory ID corresponding to the file “b.txt” is 4 (refers to the Table 1). An exemplary file table (Table 2) is shown as follows.

TABLE 2

| | Directory ID | | |
|---|---|---|---|
| | corresponding | Length of | |
| File ID | to file | file name | File name |
| 1 | 4 | 5 | a.jpg |
| 0 | 0 | 0 | 0 |
| 0 | 0 | 0 | 0 |
| 2 | 3 | 5 | c.gif |
| 3 | 5 | 5 | b.png |
| . . . | | | |
| . . . | | | |

In the file table 4, each row stores a file name, a length of the file name, a directory ID corresponding to the file, and a file ID. The file ID of each file in the file table 4 is different from the others. The zero stands for a blank row. A file path (i.e., a path of a directory including the file) can be obtained from the path table 3 according to a directory ID corresponding to the file. For example, in the Table 2, a directory ID corresponding to a file “a.jpg” is 4 (i.e., the directory ID of the directory “bbb” in the Table 1). According to an equation of “a directory path equals a parent directory path plus the directory name,” the file path of the file “a.jpg” (i.e., the directory path of “bbb”) can be obtained from the Table 1 according to the directory ID 4. The directory path of “bbb” in the Table 1 is “D:\Pictures\aaa\bbb,” so the file path of the file “a.jpg” is “D:\Pictures\aaa\bbb.”

The application 1 only stores the file ID. The application 1 sends a file ID to the file management unit 2 when a file path and a file name are in need by the application 1. Then, the file management unit 2 obtains the file path and the file name from the path table 3 and the file table 4 respectively according to the file ID, and sends the file path and the file name to the application 1. This method may reduce storage space to store the file paths and the file names.

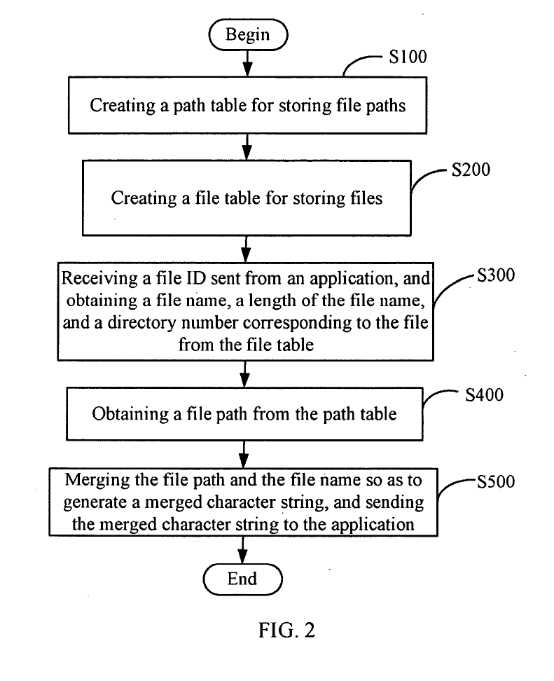

FIG. 2 is a flowchart of one embodiment of a method for storing the file paths and the file names. Depending on the embodiment, additional blocks may be added, others deleted, and arranged in a different order. In block S100, the file management unit 2 creates the path table 3. The path table 3 typically stores the file path. Each file path typically includes one or more directories. Each directory typically includes the directory name, the length of the directory name, the directory ID, and the parent directory ID of the directory.

In block S200, the file management unit 2 creates the file table 4. The file table 4 typically stores files. Each file typically includes the file name, the length of the file name, the directory ID corresponding to the file, and the file ID.

In block S300, the file management unit 2 receives a file ID sent from the application 1, and obtains a file name, a length of the file name, and a directory ID corresponding to the file from the file table 4 according to the file ID.

In block S400, the file management unit 2 obtains a file path (i.e., a path of a directory including the file) from the path table 3 according to the directory ID corresponding to the file.

In block S500, the file management unit 2 merges the file path and the file name so as to generate a merged character string, and sends the merged character string to the application 1. At the same time, the file management unit 2 sends a length of the file path and the length of the file name to the application 1. Then, the application 1 assigns the storage space for the file based on the length of the file path and the file name.

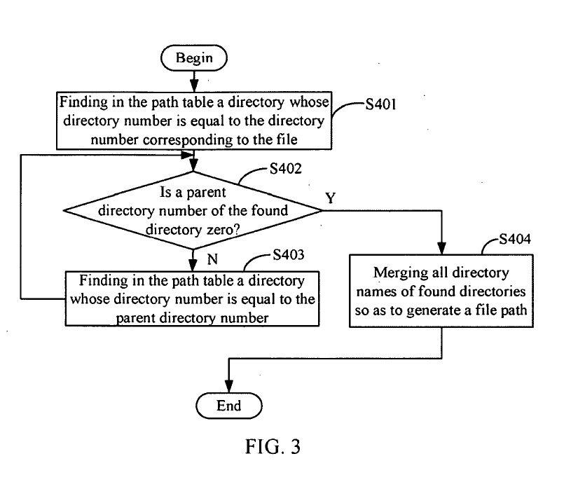

FIG. 3 is a detailed flowchart of block S400 of FIG. 2. In other words, FIG. 3 is a detailed description to execute the equation of “a directory path equals a parent directory path plus the directory name.” Depending on the embodiment, additional blocks may be added, others deleted, and arranged in a different order. In block S401, the file management unit 2 finds in the path table 3 a directory whose directory ID is equal to the directory ID corresponding to the file.

In block S402, the file management unit 2 determines if a parent directory ID of the found directory is zero.

In block S403, if the parent directory ID of the found directory is not zero, then the file management unit 2 finds in a directory in the path table 3 whose directory ID is equal to the parent directory ID. Then, the procedure goes to the block S402.

In block S404, if the parent directory ID of the found directory is zero, the file management unit 2 merges all the directory names of the found directories with the ‘\’ character so as to generate a file path (i.e., a path of a directory including the file).

One embodiment of a method to find a path of a directory whose directory ID is three in the Table 1 is as follows. At first, the file management unit 2 finds a directory whose directory ID is three in the Table 1 (i.e., the directory “aaa”). Then, the file management unit 2 finds the parent directory ID of the directory “aaa” (i.e., the parent directory ID of the directory “aaa” is one), and finds a directory whose directory ID is one in the Table 1 (i.e., the directory “D:\Pictures”). As the parent directory ID of the directory “D:\Pictures” is zero, the file management unit 2 merges the directories of “D:\Pictures” and “aaa” with the ‘\’ character so as to generate the path of the directory whose directory ID is three (i.e., “D:\Pictures\aaa”).

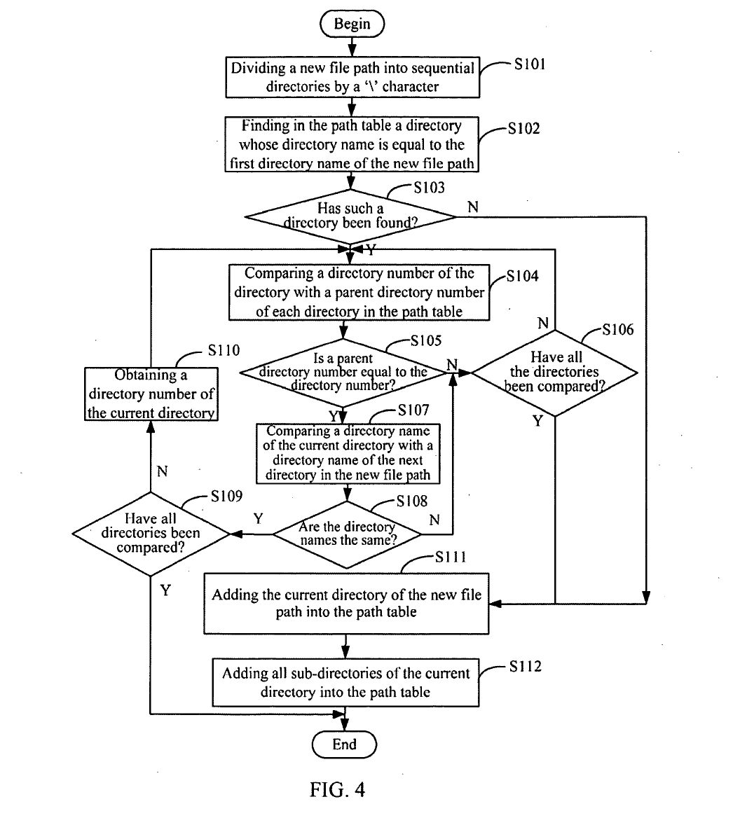

FIG. 4 is a flowchart of adding a new file path into the path table 3. Depending on the embodiment, additional blocks may be added, others deleted, and arranged in a different order. In block S101, the file management unit 2 divides a new file path into one or more sequential directories by the ‘\’ character.

In block S102, the file management unit 2 finds in the path table 3 a directory whose directory name is equal to the first directory name of the new file path.

In block S103, the file management unit 2 determines if such a directory has been found in block S102. If such a directory has not been found in block S102, then the procedure goes to block S111.

In block S104, if such a directory has been found in block S102, the file management unit 2 obtains a directory ID of the directory, and compares the directory ID with a parent directory ID of each directory in the path table 3.

In block S105, the file management unit 2 determines if a parent directory ID of a current directory in the path table 3 is equal to the directory ID.

In block S106, if the parent directory ID of the current directory is not equal to the directory ID, the file management unit 2 further determines if all the directories in the path table 3 have been compared. If any directory has not been compared, the procedure goes to block S104. If all directories have been compared, then the procedure goes to block S111.

In block S107, if the parent directory ID of the current directory is equal to the directory ID, the file management unit 2 further compares a directory name of the current directory with a directory name of a next directory in the new file path.

In block S108, the file management unit 2 determines if the directory name of the current directory is equal to the directory name of the next directory in the new file path. If the directory name of the current directory does not equal to the directory name of the next directory in the new file path, the procedure goes to block S106.

In block S109, if the directory name of the current directory is equal to the directory name of the next directory in the new file path, the file management unit 2 determines if all directories in the new file path have been compared. If all directories in the new file path have been compared, then the procedure ends. If any directory in the new file path has not been compared, the procedure goes to block S110.

In the block S110, the file management unit 2 obtains a directory ID of the current directory in the new file path, then the procedure goes to the block S104.

In block S111, the file management unit 2 adds the current directory in the new file path into the path table 3. The current directory includes a directory name, a length of the directory name, a directory ID, and a parent directory ID of the current directory.

In block S112, the file management unit 2 adds all sub-directories of the current directory into the path table 3. Each sub-directory typically includes a directory name, a length of the directory name, a directory ID, and a parent directory ID.

One embodiment of a method to add a new file path “D:\Pictures\aaa\efg” into the Table 1 is as follows. At first, the file management unit 2 divides “D:\Pictures\aaa\efg” into three sequential directories “D:\Pictures,” “aaa,” and “efg,” and starts to find each directory in the path table 3 in turn. Secondly, the file management unit 2 obtains a directory ID of the directory “D:\Pictures” (as shown in the Table 1 is one), and finds a directory whose parent directory ID is one and directory name is “aaa.” Thirdly, the file management unit 2 obtains a directory ID of the directory “aaa” (as shown in the Table 1 is three), and finds a directory whose parent directory ID is three and directory name is “efg.” As the directory whose parent directory ID is three and directory name is “efg” is not found in the Table 1, the file management unit 2 adds the directory “efg” into the Table 1. That is to say, the file management unit 2 adds the new file path of “D:\Pictures\aaa\efg” into the Table 1 so as to generate a Table 1-A shown as follows.

TABLE 1-A

| Parent | | Length of | Directory |
|---|---|---|---|
| directory ID | Directory ID | directory name | name |
| 0 | 1 | 15 | D:\Pictures |
| 0 | 2 | 13 | D:\Sounds |
| 1 | 3 | 3 | aaa |
| 3 | 4 | 3 | bbb |
| 1 | 5 | 3 | ccc |
| 3 | 6 | 3 | efg |
| . . . | | | |

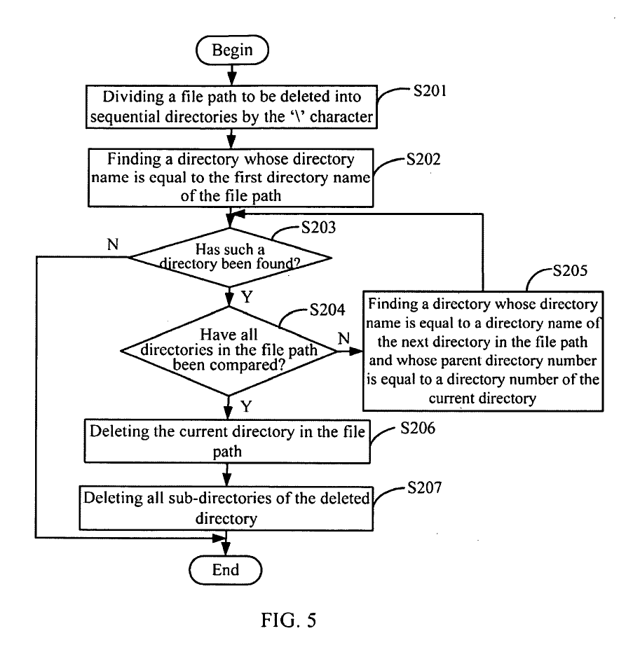

FIG. 5 is a flowchart of one embodiment of a method to delete a file path from the path table 3 of the present disclosure. Depending on the embodiment, additional blocks may be added, others deleted, and arranged in a different order. In block S201, the file management unit 2 divides a file path to be deleted into sequential directories by the ‘\’ character.

In block S202, the file management unit 2 finds a directory whose directory name is equal to the first directory name of the file path.

In block S203, the file management unit 2 determines if such a directory has been found in the block S202. If such a directory has not been found in block S202, the file management unit 2 returns a failure message, the procedure ends.

In block S204, if such a directory has been found in block S202, the file management unit 2 determines if all directories in the file path have been compared.

In block S205, if any directory in the file path has not been compared, then the file management unit 2 finds a directory whose directory name is equal to a directory name of the next directory in the file path and whose parent directory ID is equal to a directory ID of the current directory in the file path, and the procedure goes to block S203.

In block S206, if all directories in the file path have been compared, the file management unit 2 deletes the current directory in the file path.

In block S207, the file management unit 2 further deletes all sub-directories of the deleted directory. One embodiment of the management unit 2 deleting all sub-directories is as follows. The file management unit 2 finds directories whose parent directory ID is equal to a directory ID of the deleted directory, then deletes the found directories, and repeats the operation until all sub-directories of the deleted directory are deleted.

One embodiment of a method to delete a file path of “D:\Pictures\aaa” from the Table 1 is as follows. At first, the file management unit 2 divides “D:\Pictures\aaa” into two sequential directories “D:\Pictures” and “aaa,” and starts to find each directory in the path table 3 in turn. Secondly, the file management unit 2 obtains a directory ID of the directory “D:\Pictures” (as shown in the Table 1 is one), and finds a directory whose parent directory ID is one and directory name is “aaa.” Thirdly, as the directories of “D:\Pictures” and “aaa” are both found in the Table 1, the file management unit 2 deletes the directory “aaa” (i.e., the file path of “D:\Pictures\aaa”), and deletes all sub-directories of the directory “aaa” (i.e., the directory whose parent directory ID is three) so as to generate a Table 1-B shown as follows.

TABLE 1-B

| Parent | | Length of | Directory |
|---|---|---|---|
| directory ID | Directory ID | directory name | name |
| 0 | 1 | 15 | D:\Pictures |
| 0 | 2 | 13 | D:\Sounds |
| 0 | 0 | 0 | 0 |
| 0 | 0 | 0 | 0 |
| 1 | 5 | 3 | ccc |
| . . . | | | |
| . . . | | | |

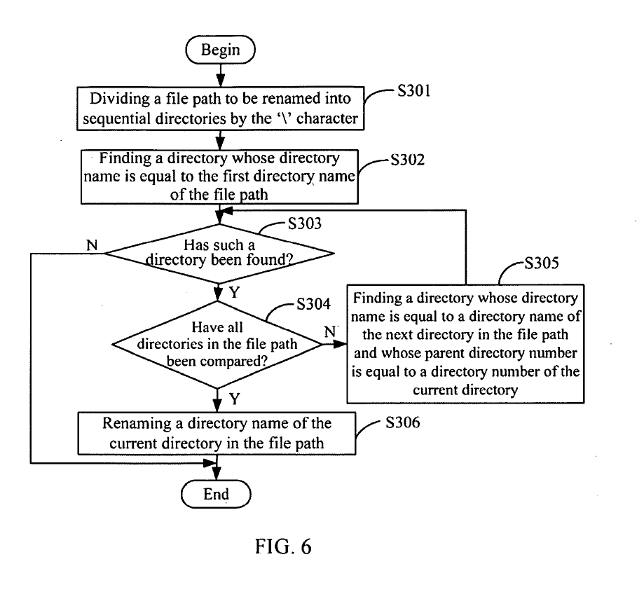

FIG. 6 is a flowchart of a method to rename a directory name of a file path in the path table 3 of the present disclosure. Depending on the embodiment, additional blocks may be added, others deleted, and arranged in a different order. In block S301, the file management unit 2 divides a file path to be renamed into sequential directories by the ‘\’ character.

In block S302, the file management unit 2 finds a directory whose directory name is equal to the first directory name of the file path.

In block S303, the file management unit 2 determines if such a directory has been found in block S302. If such a directory has not been found in block S302, then the procedure ends.

In block S304, if such a directory has been found in block S302, the file management unit 2 determines if all directories in the file path have been compared.

In block S305, if any directory in the file path has not been compared, then the file management unit 2 finds a directory whose directory name is equal to a directory name of the next directory in the file path and whose parent directory ID is equal to a directory ID of the current directory in the file path, and the procedure goes to block S303.

In block S306, if all directories in the file path have been compared, the file management unit 2 renames a directory name of the current directory in the file path.

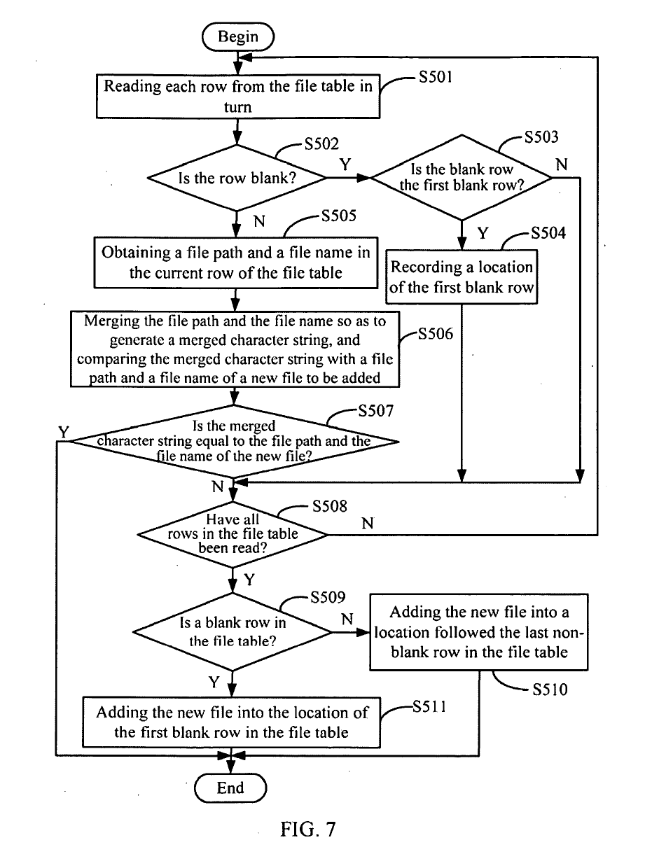

FIG. 7 is a flowchart of one embodiment of a method to add a new file into the file table 4 of the present disclosure. Depending on the embodiment, additional blocks may be added, others deleted, and arranged in a different order. In block S501, the file management unit 2 reads each row from the file table 4 in turn. The new file to be added typically includes a file path and a file name.

In block S502, the file management unit 2 determines if the row is blank. If the row is blank, the procedure goes to block S503. If the row is not blank, the procedure goes to block S505.

In block S503, the file management unit 2 further determines if the blank row is the first blank row. If the blank row is the first blank row, the procedure goes to block S504. If the blank row is not the first blank row, the procedure goes to block S508.

In block S504, the file management unit 2 records a location of the first blank row, then the procedure goes to block S508.

In block S505, the file management unit 2 obtains a file path and a file name in the current row of the file table 4. The file path is obtained from the path table 3 according to a directory ID corresponding to the file. A detailed description refers to the FIG. 3.

In block S506, the file management unit 2 merges the file path and the file name so as to generate a merged character string, and compares the merged character string with the file path and the file name of the new file.

In block S507, the file management unit 2 determines if the merged character string is equal to the file path and the file name of the new file. If the merged character string is equal to the file path and the file name of the new file, the procedure ends. If the merged character string is not equal to the file path and the file name of the new file, the procedure goes to block S508.

In block S508, the file management unit 2 further determines if all rows in the file table 4 have been read. If any row has not been read, the procedure goes to block S501. If all rows have been read, the procedure goes to block S509.

In block S509, the file management unit 2 determines if a blank row is in the file table 4.

In block S510, if there is no blank row in the file table 4, the file management unit 2 adds the new file into a location followed the last non-blank row in the file table 4. The new file typically includes a file name, a length of the file name, a file ID, and a directory ID corresponding to the new file. One embodiment of a method for obtaining the directory ID corresponding to the new file is as follows. The file management unit 2 adds the file path of the new file into the path table 3 using the method described in the FIG. 4, and obtains a corresponding directory ID (i.e., the directory ID corresponding to the file). If the file path of the new file is stored in the path table 3, the directory ID corresponding to the new file is equal to the directory ID of a directory including the new file in the path table 3.

In block S511, if there is a blank row in the file table 4, the file management unit 2 adds the new file into the location of the first blank row in the file table 4. The new file typically includes a file name, a length of the file name, a file ID, and a directory ID corresponding to the new file. The method for obtaining the directory ID corresponding to the new file is described in the block S510.

One embodiment of a method to add a new file of “D:\Pictrues\aaa\d.png” into the Table 2 is as follows. “D:\Pictures\aaa” is the file path, “d.png” is the file name. At first, the file management unit 2 read each row from the Table 2 in turn, and records a location of the first blank row in the Table 2. The location of the first blank row is configured for storing the file “D:\Pictures\aaa\d.png.” Secondly, the file management unit 2 merges a file path and a file name in each row of the Table 2 so as to generate a merged character string, and compares the merged character string with “D:\Pictures\aaa\d.png.” The file path in each row of the Table 2 is obtained from the Table 1 according to a directory ID corresponding to the file. Thirdly, as there is no merged character string which is equal to “D:\Pictures\aaa\d.png” in the Table 2, the file management unit 2 adds “d.png,” a length of “d.png,” a file ID, and a directory ID corresponding to “D:\Pictures\aaa\d.png” in the location of the first blank row in the Table 2. At the same time, the file management unit 2 adds the file path “D:\Pictures\aaa” into the Table 1 using the method described in the FIG. 4. As the file path “D:\Pictures\aaa” is stored in the Table 1, the directory ID corresponding to “D:\Pictures\aaa\d.png” is the directory ID of the directory “aaa.” The directory ID of the directory “aaa” in the Table 1 is three. The results are shown in Table 2-A when the file “D:\Pictures\aaa\d.png” is added into the Table 2.

TABLE 2-A

| | Directory ID | | |
|---|---|---|---|
| | corresponding to | Length of file | |
| File ID | file | name | File name |
| 1 | 4 | 5 | a.jpg |
| 4 | 3 | 5 | d.png |
| 0 | 0 | 0 | 0 |
| 2 | 3 | 5 | c.gif |
| 3 | 5 | 5 | b.png |
| . . . | | | |
| . . . | | | |

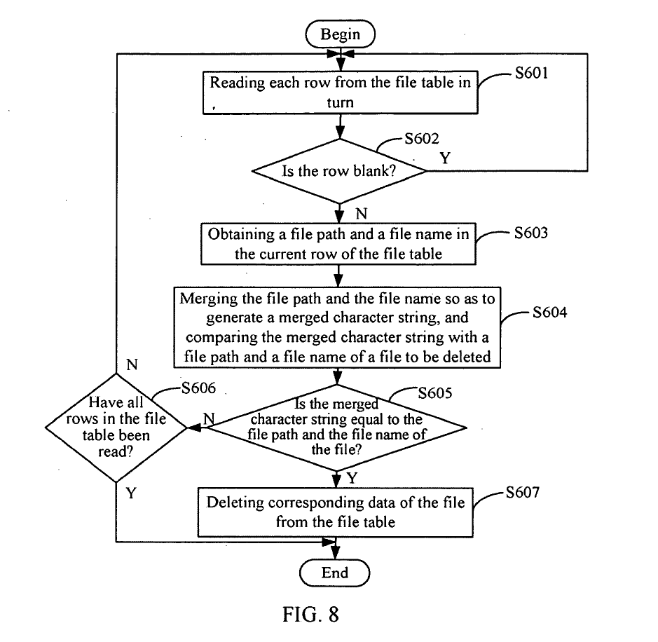

FIG. 8 is a flowchart of one embodiment of a method to delete a file from the file table 4 of the present disclosure. Depending on the embodiment, additional blocks may be added, others deleted, and arranged in a different order. In block S601, the file management unit 2 reads each row from the file table 4 in turn. The file to be deleted typically includes a file path and a file name.

In block S602, the file management unit 2 determines if the row is blank. If the row is blank, the procedure goes to block S601. If the row is not blank, the procedure goes to block S603.

In block S603, the file management unit 2 obtains a file path and a file name in the current row of the file table 4. The file path is obtained from the path table 3 according to a directory ID corresponding to the file. A detailed description refers to the FIG. 3.

In block S604, the file management unit 2 merges the file path and the file name so as to generate a merged character string, and compares the merged character string with the file path and the file name of the file to be deleted.

In block S605, the file management unit 2 determines if the merged character string is equal to the file path and the file name of the file to be deleted. If the merged character string is not equal to the file path and the file name of the file to be deleted, the procedure goes to block S606. If the merged character string is equal to the file path and the file name of the file to be deleted, the procedure goes to block S607.

In block S606, the file management unit 2 further determines if all rows in the file table 4 have been read. If any row has not been read, the procedure goes to block S601. If all rows have been read, the file management unit 2 returns an error message, and the procedure ends.

In block S607, the file management unit 2 deletes the file. The file typically includes a file name, a length of the file name, a file ID, and a directory ID corresponding to the file.

One embodiment of a method to delete a file of “D:\Pictrues\aaa\c.gif” from the Table 2 is as follows, “D:\Pictures\aaa” is the file path, “c.gif” is the file name. At first, the file management unit 2 read each row from the Table 2 in turn, merges a file path and a file name in each row of the Table 2 so as to generate a merged character string, and compares the merged character string with “D:\Pictures\aaa\d.png.” The file path in each row of the Table 2 is obtained from the Table 1 according to a directory ID corresponding to the file. Secondly, as there is a merged character string which is equal to “D:\Pictures\aaa\c.gif” in the Table 2 (i.e., the file whose file ID is two), the file management unit 2 deletes corresponding data of the file “D:\Pictures\aaa\c.gif” from the Table 2 so as to generate a Table 2-B shown as follows.

TABLE 2-B

| | Directory ID | | |
|---|---|---|---|
| | corresponding to | Length of file | |
| File ID | file | name | File name |
| 1 | 4 | 5 | a.jpg |
| 0 | 0 | 0 | 0 |
| 0 | 0 | 0 | 0 |
| 2 | 3 | 5 | c.gif |
| 3 | 5 | 5 | b.png |
| . . . | | | |
| . . . | | | |

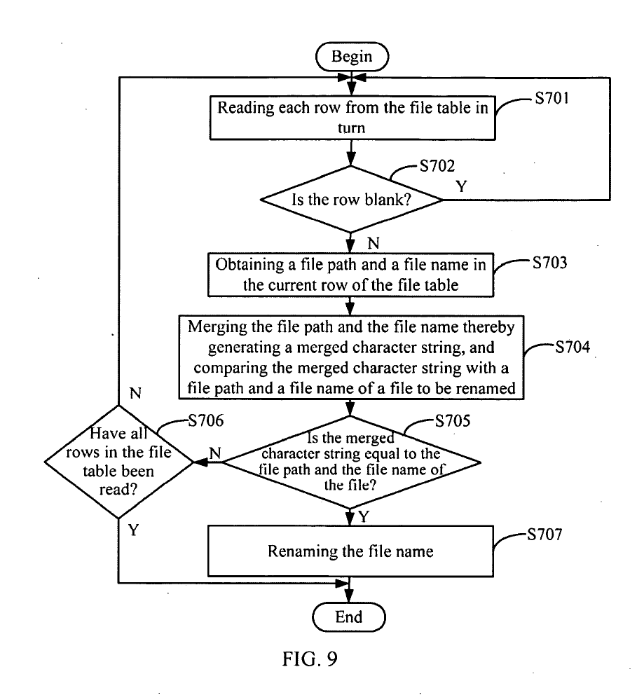

FIG. 9 is a flowchart of one embodiment of a method to rename a file name in the file table 4 of the present disclosure. Depending on the embodiment, additional blocks may be added, others deleted, and arranged in a different order. In block S701, the file management unit 2 reads each row from the file table 4 in turn.

In block S702, the file management unit 2 determines if the row is blank. If the row is blank, the procedure goes to block S701. If the row is not blank, the procedure goes to block S703.

In block S703, the file management unit 2 obtains a file path and a file name in the current row of the file table 4. The file path is obtained from the path table 3 according to a directory ID corresponding to the file. A detailed description refers to the FIG. 3.

In block S704, the file management unit 2 merges the file path and the file name so as to generate a merged character string, and compares the merged character string with a file path and a file name of the file to be renamed.

In block S705, the file management unit 2 determines if the merged character string is equal to the file path and the file name of the file to be renamed. If the merged character string is not equal to the file path and the file name of the file to be renamed, the procedure goes to block S706. If the merged character string is equal to the file path and the file name of the file to be renamed, the procedure goes to block S707.

In block S706, the file management unit 2 further determines if all rows in the file table 4 have been read. If any row has not been read, the procedure goes to block S701. If all rows have been read, the file management unit 2 returns a failure message, and the procedure ends.

In block S707, the file management unit 2 renames the file name.

It should be emphasized that the above-described embodiments of the present disclosure, particularly, any exemplary embodiments, are merely possible examples of implementations, merely set forth for a clear understanding of the principles of the present disclosure. Many variations and modifications may be made to the above-described embodiment(s) of the present disclosure without departing substantially from the spirit and principles of the present disclosure. All such modifications and variations are intended to be included herein within the scope of this disclosure and the present disclosure and protected by the following claims.

What is claimed is:

1. A computer-implemented method for storing file paths and file names, the method comprising:
creating a path table configured for storing file paths, each file path including one or more directories, each directory including a directory name, a length of the directory name, a directory ID, and a parent directory ID of the directory;
creating a file table configured for storing files, each file including a file name, a length of the file name, a directory ID corresponding to the file, and a file ID;
receiving a file ID sent from an application, and obtaining a file name, a length of the file name, and a directory ID corresponding to the file from the file table according to the file ID;
obtaining a file path from the path table according to the directory ID corresponding to the file; and
merging the file path and the file name so as to generate a merged character string, and sending the merged character string, a length of the file path and a length of the file name to the application for assigning storage space for the file based on the length of the file path and the file name.

2. The method according to claim 1, wherein the block of obtaining a file path from the path table according to the directory ID corresponding to the file comprises:
(a1) finding in the path table a directory whose directory ID is equal to the directory ID corresponding to the file;
(a2) determining if a parent directory ID of the found directory is zero, if the parent directory ID of the found directory is not zero, the procedure going to block (a3), otherwise the procedure going to block (a4);
(a3) finding in the path table a directory whose directory ID is equal to the parent directory ID, and the procedure going to the block (a2); and
(a4) merging all directory names of found directories with a backslash character (‘\’) so as to generate a file path.

3. The method according to claim 1, wherein the block of creating a path table comprises a block of adding a new file path into the path table, wherein the block of adding a new file path into the path table comprises:
(b1) dividing a new file path into sequential directories;
(b2) comparing the first directory name of the new file path with a directory name of each directory in the path table, and obtaining a directory ID whose directory name is the same as the first directory name;
(b3) comparing the obtained directory ID with a parent directory ID of each directory in the path table to obtain a current directory whose directory ID is the same as the obtained directory ID, comparing a directory name of the current directory with a directory name of the next directory in the new file path if the parent directory ID of the current directory is the same as the obtained directory ID, and obtaining a directory ID of the current directory to repeat block (b3) upon the condition that the directory name of the current directory is the same as the directory name of the next directory in the new file path; and
(b4) adding the current directory and all sub-directories of the current directory into the path table if the current directory is not found in block (b2) and block (b3).

4. The method according to claim 1, wherein the block of creating a path table comprises a block of deleting a file path from the path table, wherein the block of deleting a file path from the path table comprises:
(c1) dividing a file path to be deleted into sequential directories;
(c2) finding a directory whose directory name is equal to the first directory name of the file path;
(c3) determining if such a directory has been found in block (c2), and going to block (c4) if such a directory has been found, or returning a failure message if such a directory has not been found;
(c4) determining if all directories in the file path have been compared, and going to block (c5) if any directory in the file path has not been compared, and going to block (c6) upon the condition that all directories in the file path have been compared;
(c5) finding a directory whose directory name is equal to a directory name of the next directory in the file path and whose parent directory ID is equal to a directory ID of the current directory in the file path;
(c6) deleting the current directory in the file path; and
(c7) deleting all sub-directories of the deleted directory.

5. The method according to claim 1, wherein the block of creating a path table comprises a block of renaming a directory name of a file path in the path table, wherein the block of renaming a directory name of a file path in the path table comprises:
(d1) dividing a file path to be renamed into sequential directories;
(d2) finding a directory whose directory name is equal to the first directory name of the file path;
(d3) determining if such a directory has been found in block (c2), and going to block (d4) if such a directory has been found, or returning a failure message if such a directory has not been found;
(d4) determining if all directories in the file path have been compared, and going to block (d5) if any directory in the file path has not been compared, or going to block (d6) if all directories in the file path have been compared;
(d5) finding a directory whose directory name is equal to a directory name of the next directory in the file path and whose parent directory ID is equal to a directory ID of the current directory in the file path to be renamed; and
(d6) renaming a directory name of the current directory in the file path.

6. The method according to claim 1, wherein the block of creating a file table comprises a block of adding a new file into the file table, wherein the block of adding a new file into the file table comprises:
(e1) reading each row from the file table in turn;
(e2) determining if the row is blank, executing block (e3) if the row is blank, determining if the blank row is the first blank row if the row is not blank, recording a location of the first blank row if the blank row is the first blank row and going to block (e4), and going to block (e4) directly upon the condition that the blank row is not the first blank row;
(e3) obtaining a file path and a file name in the current row of the file table, merging the file path and the file name so as to generate a merged character string, comparing the merged character string with a file path and a file name of a new file to be added, going to block (e4) if the merged character string is not equal to the file path and the file name of the new file;
(e4) determining if all rows in the file table have been read, and going to block (e1) if any row has not been read, or going to block (e5) if all rows have been read;
(e5) determining if a blank row is in the file table, and going to block (e6) if there is a blank row in the file table, or going to block (e7) if there is not a blank row in the file table;
(e6) adding the new file into the location of the first blank row in the file table, the new file including a file name, a length of the file name, a file ID, and a directory ID corresponding to the new file; and
(e7) adding the new file into a location followed the last non-blank row in the file table, the new file including a file name, a length of the file name, a file ID, and a directory ID corresponding to the new file.

7. The method according to claim 1, wherein the block of creating a file table comprises a block of deleting a file from the file table, wherein the block of deleting a file from the file table comprises:
(f1) reading each row from the file table in turn;
(f2) determining if the row is blank, and going to block (f1) if the row is blank, or going to block (f3) if the row is not blank;
(f3) obtaining a file path and a file name in the current row of the file table, merging the file path and the file name so as to generate a merged character string, comparing the merged character string with a file path and a file name of a file to be deleted, going to block (f4) if the merged character string is not equal to the file path and the file name of the file to be deleted, otherwise executing block (f5);
(f4) determining if all rows in the file table have been read, and going to block (f1) if any row has not been read, or returning a failure message if all rows have been read; and
(f5) deleting the file from the file table.

8. The method according to claim 1, wherein the block of creating a file table comprises a block of renaming a file name in the file table, wherein the block of renaming a file name in the file table comprises:
(g1) reading each row from the file table in turn;
(g2) determining if the row is blank, and going to block (g1) if the row is blank, or going to block (g3) if the row is not blank;
(g3) obtaining a file path and a file name in the current row of the file table, merging the file path and the file name so as to generate a merged character string, comparing the merged character string with a file path and a file name of a file to be renamed, going to block (g4) if the merged character string is not equal to the file path and the file name of the file to be renamed, otherwise executing block (g5);
(g4) determining if all rows in the file table have been read, and going to block (g1) if any row has not read, or returning a failure message if all rows have been read; and
(g5) renaming the file name.
